(19) United States
(12) Patent Application Publication
(10) Pub. No.: US 2015/0294226 A1
(43) Pub. Date: Oct. 15, 2015

(54) INFORMATION PROCESSING APPARATUS, INFORMATION PROCESSING METHOD AND PROGRAM

(71) Applicant: International Business Machines Corporation, Armonk, NY (US)

(72) Inventors: Hideyuki Mizuta, Tokyo (JP); Rikiya Takahashi, Tokyo (JP); Takayuki Yoshizumi, Tokyo (JP)

(21) Appl. No.: 14/748,307

(22) Filed: Jun. 24, 2015

Related U.S. Application Data
(63) Continuation of application No. 14/644,528, filed on Mar. 11, 2015.

(30) Foreign Application Priority Data
Mar. 27, 2014 (JP) 2014-067159

(51) Int. Cl. G06N 5/04; G06N 99/00

(52) U.S. Cl. CPC G06N 5/045; G06N 99/005

(57) ABSTRACT

An information processing apparatus optimizes an action in a transition model in which a number of objects in each state transits according to the action. A cost constraint acquisition unit acquires multiple cost constraints including one that constrains a total cost of the action over at multiple timings and/or multiple states. A processing unit assumes action distribution in each state at each timing as a decision variable in an optimization problem and maximizes an objective function subtracting a term based on an error between an actual number of objects with the action in each state at each timing and an estimated number of objects in each state at each timing based on state transition by the transition model, from a total reward in a whole period, satisfying the multiple cost constraints. An output unit outputs the action distribution in each state at each timing that maximizes the objective function.

### DOMESTIC AND FOREIGN PRIORITY

This application is a continuation of U.S. patent application Ser. No. 14/644,528, filed Mar. 11, 2015, which claims priority to Japanese Patent Application No. 2014-067159, filed Mar. 27, 2014, and all the benefits accruing therefrom under 35 U.S.C. §119, the contents of which in its entirety are herein incorporated by reference.

### BACKGROUND

The present invention relates to an information processing apparatus, an information processing method and a program.

There is known a technique of optimizing a policy in the future, based on a formulation of the sequence of past sales performance by Markov decision process or reinforcement learning (see, e.g., the publication of A. Labbi and C. Berrospi, “Optimizing marketing planning and budgeting using Markov decision processes: An airline case study”, IBM Journal of Research and Development, 51(3):421-432, 2007, the publication of N. Abe, N. K. Verma, C. Apt'e, and R. Schroko, “Cross channel optimized marketing by reinforcement learning”, In Proceedings of the 10th ACM SIGKDD Conference on Knowledge Discovery and Data Mining (KDD 2004), pages 767-772, 2004, Japanese patent publication JP2010-191963A, and Japanese patent publication JP2011-513817A. Moreover, there is known a policy optimization technique by budget-constrained Markov decision process (CMDP) that builds in the constraint of a budget only in a single timing or the whole period (see, e.g., Japanese patent publication JP2012-190062A, and the publication of G. Tirenni, A. Labbi, C. Berrospi, A. Elisseeff, T. Bhose, K. Pauro, S. Poyhonen, “The 2005 ISMS Practice Prize Winner—Customer Equity and Lifetime Management (CELM) Finnair Case Study”, Marketing Science, vol. 26, no. 4, pp. 553-565, 2007).

### SUMMARY

In one embodiment, an information processing apparatus that optimizes an action in a transition model in which a number of objects in each state transits according to the action, includes a cost constraint acquisition unit configured to acquire multiple cost constraints including a cost constraint that constrains a total cost of the action over at least one of multiple timings and multiple states; a processing unit configured to assume action distribution in each state at each timing as a decision variable in an optimization problem and maximize an objective function subtracting a term based on an error between an actual number of objects with the action in each state at each timing and an estimated number of objects in each state at each timing based on state transition by the transition model, from a total reward in a whole period, while satisfying the multiple cost constraints; and an output unit configured to output the action distribution in each state at each timing that maximizes the objective function.

In another embodiment, a computer implemented method of optimizing an action in a transition model in which a number of objects in each state transits according to the action, includes acquiring, with a processing device, multiple cost constraints including a cost constraint that constrains a total cost of the action over at least one of multiple timings and multiple states; assuming action distribution in each state at each timing as a decision variable in an optimization problem and maximize an objective function subtracting a term based on an error between an actual number of objects with the action in each state at each timing and an estimated number of objects in each state at each timing based on state transition by the transition model, from a total reward in a whole period, while satisfying the multiple cost constraints; and outputting the action distribution in each state at each timing that maximizes the objective function.

### BRIEF DESCRIPTION OF THE DRAWINGS

FIG. 1 is a block diagram of an information processing apparatus of an exemplary embodiment;

FIG. 2 illustrates a processing flow in the information processing apparatus of an exemplary embodiment;

FIG. 3 illustrates one example of cost constraint acquired by a cost constraint acquisition unit;

FIG. 4 illustrates one example of the distribution of actions output by an output unit;

FIG. 5 illustrates a specific processing flow of an exemplary embodiment;

FIG. 6 illustrates an example of classifying state vectors by a regression tree in a classification unit;

FIG. 7 illustrates an example of classifying state vectors by a binary tree in the classification unit;

FIG. 8 illustrates a processing flow in the information processing apparatus of an exemplary embodiment;

FIG. 9 illustrates one example of transition probability distribution calculated by a distribution calculation unit; and

FIG. 10 illustrates one example of a hardware configuration of a computer.

### DETAILED DESCRIPTION

With respect to the above described problems, there is not known a technique of optimizing a policy at high computational efficiency and high accuracy while taking into account cost constraints of budgets or the like over multiple timings, multiple periods and/or multiples states.

In the first aspect of the present invention, there is provided an information processing apparatus that optimizes a policy in a transition model in which a number of objects in each state transits according to the policy, including: a cost constraint acquisition unit configured to acquire multiple cost constraints including a cost constraint that bounds a total cost of the policy over at least one of multiple timings and multiple states; a processing unit configured to assume action allocation of actions for each state at each timing as a decision variable in an optimization and maximize an objective function subtracting a term based on an error between an actual number of objects with the action in each state at each timing and an estimated number of objects in each state at each timing based on the state transition supplied by the transition model, from a total reward in a whole period, while satisfying the multiple cost constraints; and an output unit configured to output the allocation of actions in each state at each timing that maximizes the objective function.

In the following, although the present invention is described through an embodiment of the invention, the following embodiment does not limit the inventions according to the claims. Moreover, all combinations of features described in the embodiment are not essential to the solving means of the invention.

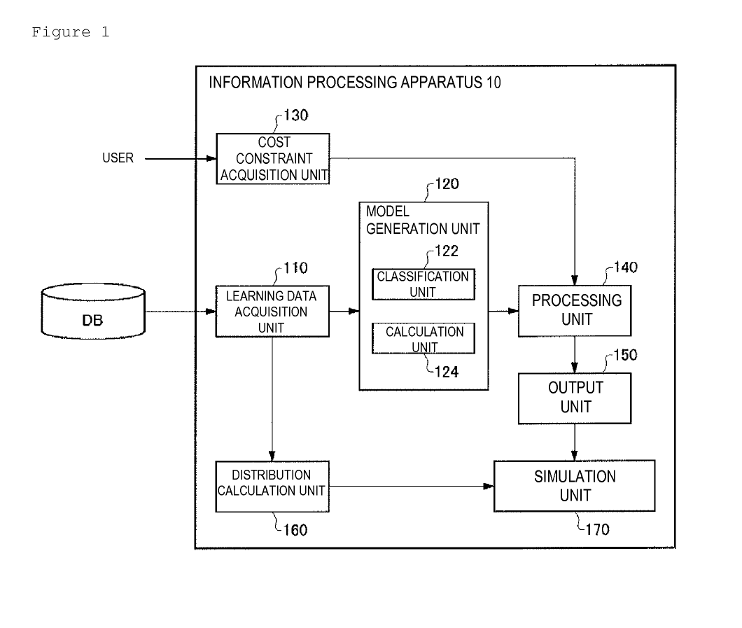

FIG. 1 illustrates a block diagram of the information processing apparatus 10 according to the present embodiment. The information processing apparatus 10 of the present embodiment optimizes a policy, taking into account cost constraint over multiple timings and/or multiple states in a transition model in which multiple states are defined and the number of objects in each state (for example, the number of objects classified into each state) transits according to the policy. The information processing apparatus 10 includes a training data acquisition unit 110, a model generation unit 120, the cost constraint acquisition unit 130, a processing unit 140, the output unit 150, the distribution calculation unit 160 and a simulation unit 170.

The training data acquisition unit 110 acquires training data that records response to a policy with respect to multiple objects. For example, the training data acquisition unit 110 acquires the record of actions such as an advertisement for objects such as multiple consumers and response such as purchase by the consumers or the like, from a database or the like, as training data. The training data acquisition unit 110 supplies the acquired training data to the model generation unit 120 and the distribution calculation unit 160.

The model generation unit 120 generates a transition model in which multiple states are defined and an object transits between the states at a certain probability, on the basis of the training data acquired by the training data acquisition unit 110. The model generation unit 120 has a classification unit 122 and a calculation unit 124.

The classification unit 122 classifies multiple objects included in the training data into each state. For example, the classification unit 122 generates the time series of state vectors for each object from the records including the response and the actions for multiple objects, which are included in the training data, and classifies multiple state vectors into multiple discrete states according to the positions on the state vector space.

The calculation unit 124 calculates a state transition probability showing a probability at which the object of each state transits to each state in multiple discrete states classified by the classification unit 122, and the previous expected reward acquired when a policy is performed in each state, by a use of regression analysis. The calculation unit 124 supplies the calculated state transition probability and expected reward to the processing unit 140.

The cost constraint acquisition unit 130 acquires multiple cost constraints including a cost constraint that bounds the total cost of the policy over at least one of multiple timings and multiple states. For example, in a continuous period including one or two or more timings, the cost constraint acquisition unit 130 acquires a budget that can be spent to perform one or two or more actions targeted for objects of one or two or more designated states, as a cost constraint. The cost constraint acquisition unit 130 supplies the acquired cost constraint to the processing unit 140.

The processing unit 140 assumes allocation of actions with respect to multiple objects in each state at each timing as a decision variable of an optimization problem and maximizes an objective function subtracting a term based on an error between an actual number of objects with the action in each state at each timing and an estimated number of objects in each state at each timing based on state transition by a transition model, from the total reward in the whole period, while satisfying multiple cost constraints, in order to acquire the optimal policy that maximizes the total of the reward for all objects in the whole period. The processing unit 140 supplies allocation of actions in each state at each timing to maximize the objective function, to output unit 150.

The output unit 150 outputs the allocation of actions in each state at each timing to maximize the objective function. The output unit 150 outputs the allocation of actions to the simulation unit 170. Moreover, the output unit 150 may display the allocation of actions on a display apparatus of the information processing apparatus 10 and/or output it to a storage medium or the like.

The distribution calculation unit 160 calculates the transition probability distribution of the object states on the basis of the training data. For example, the classification unit 122 generates a time series of state vectors every object from the record of actions with respect to multiple objects included in the training data, and so on, and calculates transition probability distribution on the basis of to which vector an object with a certain state vector transits according to the action and to which discrete-limited-number-defined state each state vector belongs. The distribution calculation unit 160 supplies the calculated transition probability distribution to the simulation unit 170.

The simulation unit 170 simulates object state transition based on the transition probability distribution calculated by the distribution calculation unit 160 and actually acquired reward, according to action distribution in each state at each timing which is output by the output unit 150.

Thus, the information processing apparatus 10 of the present embodiment outputs action distribution that satisfies cost constraint over multiple periods/multiple states, on the basis of the state transition probability and the expected reward which are calculated from the training data. By this means, according to the information processing apparatus 10, it is possible to provide optimal action allocation in an environment close to reality in which constraint related to the cost is strict.

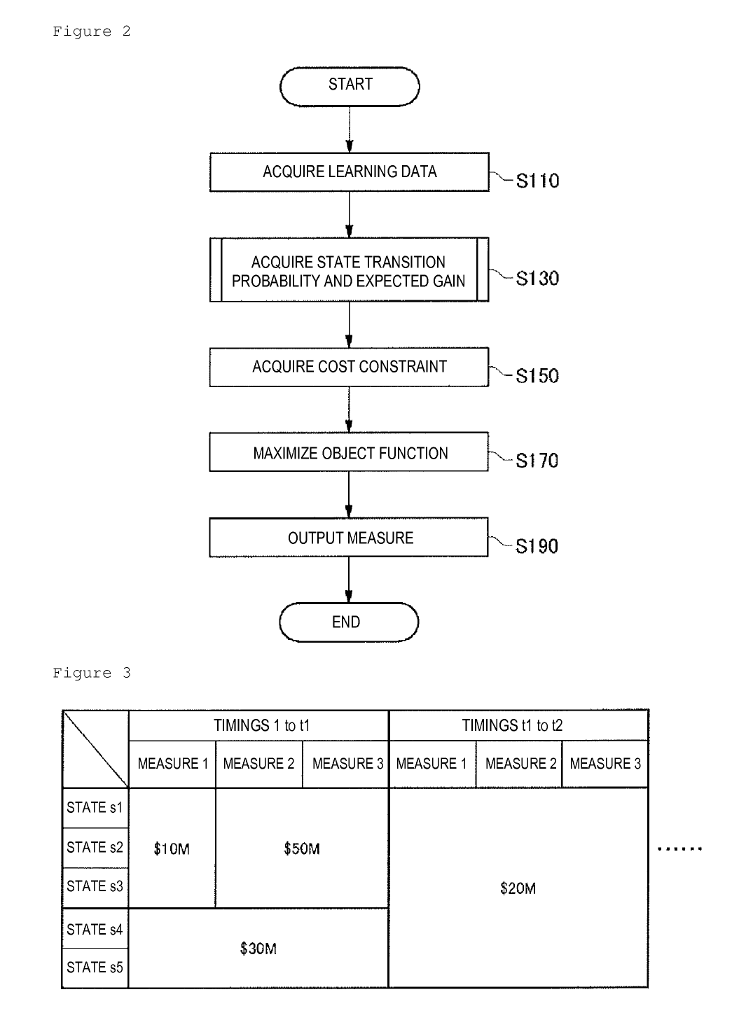

FIG. 2 illustrates a processing flow in the information processing apparatus 10 of the present embodiment. In the present embodiment, the information processing apparatus 10 outputs optimal action distribution by performing processing in S110 to S190.

First, in S110, the training data acquisition unit 110 acquires training data that records response to an action with respect to multiple objects. For example, the training data acquisition unit 110 acquires the record of the time series of object response including purchase, subscription and/or other responses of object commodities or the like when multiple customers, consumers, subscribers and/or cooperation are assumed to be objects and an action (“nothing” may be included in the set of actions) such as a direct mail, email and/or other advertisements is executed for the objects to give an impulse, as training data. The training data acquisition unit 110 supplies the acquired training data to the model generation unit 120.

Next, in S130, the model generation unit 120 classifies multiple objects included in the training data into each state and calculates the state transition probability and the expected reward in each state and each action. The model generation unit 120 supplies the state transition probability and the expected reward to the processing unit 140. Here, specific processing content of S130 is described later.

Next, in S150, the cost constraint acquisition unit 130 acquires multiple cost constraints including a cost constraint that restricts the total cost of the actions over at least one of multiple timings and multiple states. The cost constraint acquisition unit 130 may acquire a cost constraint that constrains the total cost of each action.

For example, the cost constraint acquisition unit 130 may acquire a cost constraint caused by executing the action, such as the constraint of a money cost (for example, the budget amount that can be spent on the action, and so on), the constraint of a number cost for action execution (for example, the number of times the action can be executed, and so on), the constraint of a resource cost of consumed resources or the like (for example, the total of stock biomass that can be used to execute the action, and so on) and/or the constraint of a social cost of an environmental load or the like (for example, the CO₂ amount that can be exhausted in the action, and so on), as a cost constraint. The cost constraint acquisition unit 130 may acquire one or more cost constraints and may especially acquire multiple cost constraints.

FIG. 3 illustrates one example of a cost constraint acquired by the cost constraint acquisition unit 130. As illustrated in the figure, the cost constraint acquisition unit 130 may acquire a cost constraint defined every period including the whole or partial timing, one or two or more states s and one or two or more action.

For example, the cost constraint acquisition unit 130 may acquire 10M dollars as a budget to execute action 1 and 50M dollars as a budget to execute action 2 and 3 with respect to an object in states s1 to s3 in a period from timing 1 to timing t1, and may acquire 30M dollars as a working budget of all actions with respect to an object in states s4 and s5 in the same period. Moreover, for example, the cost constraint acquisition unit 130 may acquire 20M dollars as a budget to execute all actions with respect to an object in all states in a period from timing t1 to timing t2.

Subsequent to returning to FIG. 2, in S170, the processing unit 140 calculates the value of each variable that maximizes the objective function while satisfying multiple cost constraints, assuming the distribution and error range of the action at each timing in each state as a variable of the optimization object.

One example of the objective function that is a maximization object in the processing unit 140 is shown in Equation (1).

$${max}_{π ∈ \prod , \{ {σ}_{t , s} \}} [ {\sum }_{t = 1}^{T} {γ}^{t} {\sum }_{s ∈ S} {\sum }_{a ∈ A} {n}_{t , s , a ,} {\hat{r}}_{t , s , a} - {\sum }_{t = 2}^{T} {\sum }_{s ∈ S} {η}_{t , s} {σ}_{t , s} ] \\ s . t . {Λ}_{s ∈ S} [ {\sum }_{a ∈ A} {n}_{1 , s , a} = {N}_{1 , s} ] \qquad Equation ( 1 )$$

Here, γ stands for the discount rate with respect to the future reward with 0<γ≦1 predefined, n̂t_{,s,a} stands for the number of application objects to which action “a” is distributed in state s at timing t and in state s, N_{t,s} stands for the number of objects in state s at timing t, r̂_{t,s,a} stands for the expected reward by action “a” in state s at timing t, σ_{t,s} stands for the slack variable given by the range of an error between the number of action application objects in state s at timing t and the number of estimation objects in state s at timing t according to state transition by a transition model, and η_{t,s} stands for a weight coefficient given to slack variable σ_{t,s}.

As shown in Equation (1), when the sum total in all times (t=1, . . . , T) of the value multiplying the sum total in all actions “a”∈A and all states s∈S of the product of application object number n_{t,s,a} and expected reward r̂_{t,s,a} by power γ^{t} of the discount rate corresponding to each time t is assumed to be a term based on the total reward in the whole period and the sum total in all states and all times after t=2 of the product of weight coefficient η_{t,s} and slack variable σ_{t,s} is assumed to be a term based on an error, the objective function is acquired by subtracting the term based on the error from the term based on the total reward in the whole period.

Here, Σₐ∈_{A}n_{1,s,a}=N_{1,s} in Equation (1) defines the sum total in all actions “a”∈A of application object number n_{t,s,a} to which direct action “a” is distributed in state s at the start timing (timing 1) of the period, by object number N_{t,s}. By this means, the processing unit 140 determinately gives the number of objects (for example, population) in each state s at the start timing.

Weight coefficient η_{t,s} may be a predefined coefficient, and, instead of this, the processing unit 140 may calculate weight coefficient η_{t,s} from η_{t,s}=λγ^{t}Σ₍ₐ∈_{A)}|r̂_{t,s,a}|. Here, λ is a global relaxation hyper parameter, and, for example, the processing unit 140 may select λ from 1, 10, 10⁻¹, 10² and 10⁻², and may set optimal λ on the basis of the discontinuous state Markov decision process or the result of agent base simulation.

A constraint with respect to slack variable σ_{t,s} that is an optimization object in the processing unit 140 is shown in Equations (2) and (3).

$$\begin{matrix}{Λ}_{t = 1}^{T - 1} {Λ}_{s ∈ S} [ {σ}_{t + 1 , s} \geq ( {\sum }_{a ∈ A} {n}_{t + 1 , s , a} - {\sum }_{{s}^{′} ∈ S} {\sum }_{{a}^{′} ∈ A} {\hat{p}}_{s \vert {s}^{′} , {a}^{′}} {n}_{t , {s}^{′} , {a}^{′}} ) ] & Equation ( 2 ) \\ {Λ}_{t = 1}^{T - 1} {Λ}_{s ∈ S} [ {σ}_{t + 1 , s} \geq - ( {\sum }_{a ∈ A} {n}_{t + 1 , s , a} - {\sum }_{{s}^{′} ∈ S} {\sum }_{{a}^{′} ∈ A} {\hat{p}}_{s \vert {s}^{′} , {a}^{′}} {n}_{t , {s}^{′} , {a}^{′}} ) ] & Equation ( 3 )\end{matrix}$$

Here, p̂_{s|s′,a} stands for a state transition probability corresponding to a probability of transition from state s′ to state s when action “a” is executed.

The equations in parentheses in the right side of inequalities of Equations (2) and (3) show an error between the number of action application objects at each timing in each state and the number of estimation objects at each timing in each state based on state transition by the transition model.

For example, Σn_{t+1,s,a} denotes the sum total with respect to all actions “a”∈A of the application object number of action “a” in each state s at one timing t+1. The processing unit 140 actually assigns the number of objects of Σn_{t-1,s,a} to a segment in timing t+1 and state s.

Moreover, for example, ΣΣp̂_{s|s′,a′}n_{t,s′,a} denotes the sum total with respect to all states s′∈S and all actions a′∈A of the number of estimation objects calculated by the processing unit 140 by estimating that it transits to one timing t+1 and each state s by state transition based on the distribution of the application object number n_{t,s′,a} and state transition probability p̂_{s|s′,a} of action “a” in each states'(s′∈S) of timing t previous to one timing t+1.

That is, the equations in the parentheses on the right side of the inequalities of Equations (2) and (3) show an error between the number of actual objects existing in timing t+1 and state s and the number of estimation objects estimated by the state transition probability and the number of objects in previous timing t. The processing unit 140 gives the absolute value of the error to lower limit value of slack variable σ_{t,s} by constraint of the inequalities of Equations (2) and (3). Therefore, slack variable σ_{t,s} increases under the condition that the error is estimated to be large and the reliability of the transition model is estimated to be low.

Here, the processing unit 140 may assume the larger value that is one of 0 and the error as the lower limit value of slack variable σ_{t,s} instead of giving the absolute value of the error to the lower limit value of slack variable σ_{t,s}.

In Equation (1), there is a relationship that the objective function decreases when a term based on the error increases, and the term based on the error increases in proportion to slack variable σ_{t,s.} By this means, the processing unit 140 calculates a condition of keeping the size of the total reward and the degree of reliability at the same time by installing the low degree of reliability of the transition model into the objective function as a penalty value and maximizing the objective function.

The processing unit 140 maximizes the objective function by further using a cost constraint shown in Equation (4).

$${Λ}_{i = 1}^{I} ⌈ {\sum }_{( t , s , a ) ∈ {Z}_{i}} {c}_{t , s , a} {n}_{t , s , a} ⋛ {C}_{i} ⌉ \qquad Equation ( 4 )$$

Here, c_{t,s,a} stands for a cost in a case where action “a” is executed in state s at timing t, and Cᵢ stands for the specified value, upper limit value or lower limit value of the total cost about the i-th (i=1, . . . , I, where “I” denotes an integer equal to or greater than 1) cost constraint. The cost may be predefined every timing t, state s and/or action “a”, or may be acquired from the user by the cost constraint acquisition unit 130.

The processing unit 140 maximizes the objective function by further using a constraint condition related to the number of objects shown in Equation (5).

$${Λ}_{t = 1}^{T} [ {\sum }_{s ∈ S} {\sum }_{a ∈ S} {n}_{t , s , a} = N ] \qquad Equation ( 5 )$$

Here, N stands for the total object number (for example, population of all consumers) that is predefined or to be defined by the user.

Equation (5) shows a constraint condition that the total of application object number n_{t,s,a} of action “a” at each timing t in each state s is equal to total object number N predefined. By this means, the processing unit 140 includes a condition that the number of action object persons at all times in all states is always equal to the population of all consumers, in the constraint condition.

By solving a linear programming problem or mixed integer programming problem including the constraints shown in Equations (1) to (5), the processing unit 140 calculates action distribution with respect to application object number n_{t,s,a} assigned to each timing t, each state s and each action “a”. The processing unit 140 supplies calculated action distribution to the output unit 150.

Next, in S190, the output unit 150 outputs the action distribution in each state at each timing to maximize the objective function.

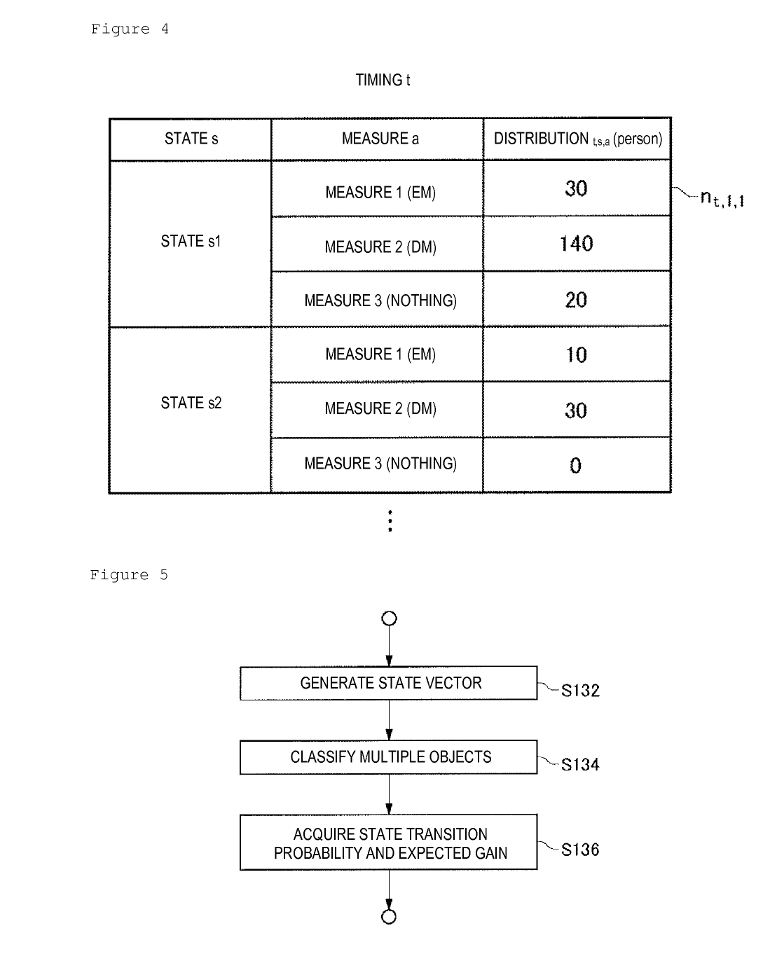

FIG. 4 illustrates one example of the action distribution output by the output unit 150. As illustrated in the figure, the output unit 150 outputs application object number n_{t,s,a} of each action “a” every timing t and state s. For example, the output unit 150 outputs action distribution showing that action 1 (for example, email) is implemented for 30 people, action 2 (for example, direct mail) is implemented for 140 people and action 3 (for example, nothing) is implemented for 20 people, with respect to the object persons in state s1 at time t. Moreover, the output unit 150 outputs action distribution showing that action 1 is implemented for 10 people, action 2 is implemented for 30 people and action 3 is implemented for 0 people, with respect to the object persons in state s2 at time t.

Thus, the information processing apparatus 10 of the present embodiment outputs action distribution that satisfies a cost constraint over multiple timings, multiple periods and/or multiple states on the basis of the training data. By this means, for example, even in a case where a budget allocated to each of multiple sections in an organization in a certain period is limited by various factors, the information processing apparatus 10 can output optimal action distribution that suits the budget of each section.

Specifically, by installing a term related to an object number error, that is, a term including a slack variable in the objective function that is a maximization object, the information processing apparatus 10 can treat a cost constraint over multiple timings, multiple periods and/or multiple states as a problem that can be solved at high speed such as a linear programming problem, and output the action distribution that gives a big total reward at high accuracy. By contrast with this, in a case where the term related to the object number error is not included in the objective function that is the maximization object, since there is a possibility that action distribution that maximizes the total reward in a large-error or less-accuracy transition model is output, there occurs a possibility that action distribution that does not maximize the total reward as a result is output.

Moreover, since the information processing apparatus 10 performs optimization by a linear programming problem or the like, it is possible to solve a problem of an extremely high level model, that is a model having many kinds of states and/or actions. In addition, the information processing apparatus 10 can be easily extended even to a multi-object optimization problem. For example, in a case where expected reward r_{t,s,a} is not a simple scalar but has multiple values (for example, in the case of separately considering sales of an Internet store and sales of a real store), the information processing apparatus 10 can easily perform optimization by assuming a multi-objective function shown by a linear combination of these values to be an objective function.

FIG. 5 illustrates a specific processing flow of S130 of the present embodiment. The model generation unit 120 performs processing in S132 to S136 in the processing in S130.

First, in S132, based on response and actions with respect to each of multiple objects included in training data, the classification unit 122 of the model generation unit 120 generates state vectors of the objects. For example, with respect to each of the objects in a predefined period, the classification unit 122 generates a state vector having a value based on an action executed for the object and/or response of the object as a component.

As an example, the classification unit 122 may generate a state vector having: the number of times one certain consumer performs purchase in previous one week, as the first component; the number of times the one consumer performs purchase in previous two weeks, as the second component; the number of direct mails transmitted to the one consumer in previous one week, as the third component.

Next, in S134, the classification unit 122 classifies multiple objects on the basis of the state vectors. For example, the classification unit 122 classifies multiple objects by applying supervised learning or unsupervised learning and suiting a decision tree to a state vector.

As an example of the supervised learning, the classification unit 122 classifies the state vectors according to multiple objects in an axis in which the prediction accuracy at the time of performing regression on the future reward by the state vectors becomes maximum. For example, the classification unit 122 assumes a state vector of one object as input vector x, assumes a vector showing response from an object in a predefined period after the time at which the state vector of the one object is observed (for example, a vector assuming the sales of each product recorded during one year from the observation timing of the state vector, as a component), as output vector y, and suits a regression tree in which output vector y can be predicted at highest accuracy. By assigning each state every leaf node of the regression tree, the classification unit 122 discretizes the state vectors according to multiple objects and classifies multiple objects into multiple states.

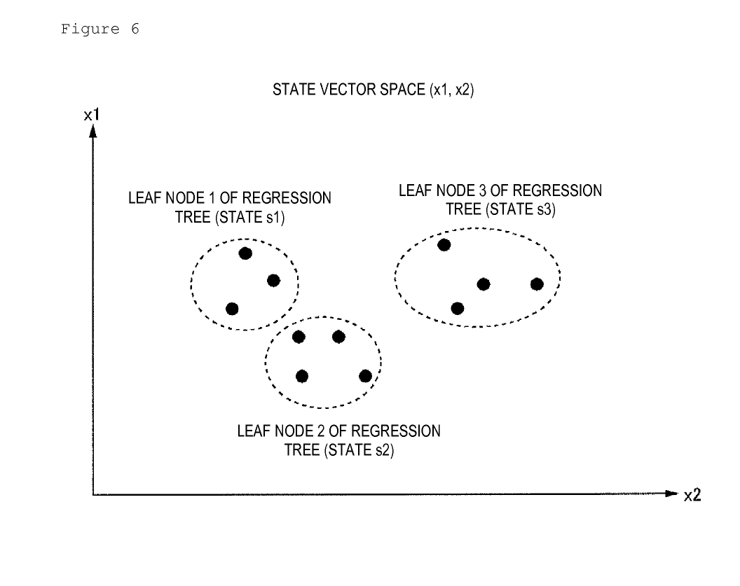

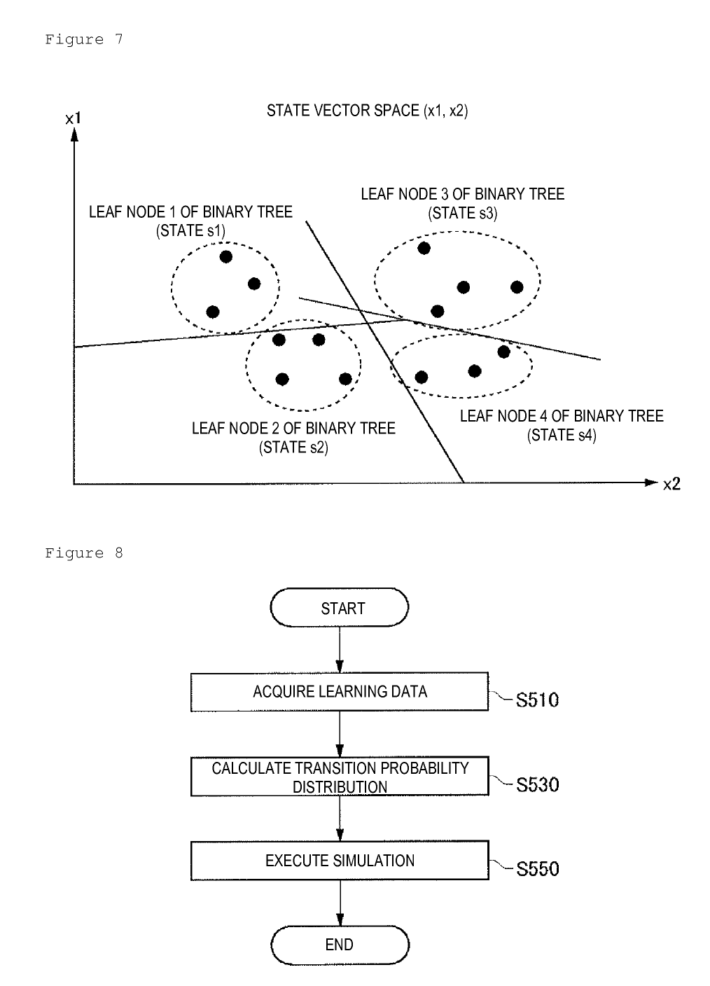

FIG. 6 illustrates an example in which the classification unit 122 classifies the state vectors by the regression tree. Here, an example is shown where the classification unit 122 classifies multiple state vectors having two components of x1 and x2. The vertical axis and horizontal axis of the graph in the figure show the scale of components x1 and x2 of the state vectors, multiple points plotted in the graph show multiple state vectors corresponding to multiple objects, and the regions enclosed with broken lines show the state vector ranges that become conditions included in the leaf nodes of the regression tree.

As illustrated in the figure, the classification unit 122 classifies multiple state vectors every leaf node of the regression tree. By this means, the classification unit 122 classifies multiple state vectors into multiple states s1 to s3.

As an example of the unsupervised learning, by classifying the state vectors according to multiple objects by a binary tree that divides the state vector space into two by the use of a threshold in an axis in which variance of the state vectors becomes maximum, the classification unit 122 discretizes the state vectors according to multiple objects and classifies multiple objects into multiple states.

FIG. 7 illustrates an example where the classification unit 122 classifies state vectors by a binary tree. Similar to FIG. 6, the vertical axis and horizontal axis of the graph in the figure show the scale of components x1 and x2 of the state vectors, and multiple points plotted in the graph show the state vectors corresponding to multiple objects.

The classification unit 122 calculates an axis by which, when multiple state vectors are divided by the axis and classified into multiple groups, the total of the variance of the state vectors of all divided groups becomes maximum, and performs discretization by dividing multiple state vectors into two by the calculated axis. As illustrated in the figure, by repeating the division predefined times, the classification unit 122 classifies multiple state vectors according to multiple objects into multiple states s1 to s4.

Returning to FIG. 5, next, in S136, the calculation unit 124 calculates state transition probability p̂_{s|s′,a} and expected reward r̂_{t,s,a}. For example, the calculation unit 124 calculates state transition probability p̂_{s|s′,a} by performing regression analysis on the basis of to which state the object of each state classified by the classification unit 122 transits according to the action. As an example, the calculation unit 124 may calculate state transition probability p̂_{s|s′,a} by using Modified Kneser-Ney Smoothing.

Moreover, for example, the calculation unit 124 calculates expected reward r̂_{t,s,a} by performing regression analysis on the basis of how much amount of expected reward is given immediately after the object of each state classified by the classification unit 122 executes the action. As an example, the calculation unit 124 may calculate expected reward r̂_{t,s,a} accurately by the use of L1-regularization Poisson regression and/or L1-regularization log-normal regression. Here, the calculation unit 124 may use the result of subtracting the cost necessary for action execution from the expected benefit at the time of executing the action (for example, sales-marketing cost), as an expected reward.

FIG. 8 illustrates a processing flow in the information processing apparatus 10 of the present embodiment. In the present embodiment, the information processing apparatus 10 simulates a result of performing distribution of the output actions more accurately by performing processing in S510 to S550.

First, in S510, the training data acquisition unit 110 acquires training data that records response to an action with respect to multiple objects. For example, the training data acquisition unit 110 may acquire the same training data as the training data acquired in S110, and, instead of this, may acquire training data in a different period with respect to the same object as that of the training data acquired in S110 or an object including at least part of the same object. The training data acquisition unit 110 supplies the acquired training data to the distribution calculation unit 160.

Next, in S530, the distribution calculation unit 160 calculates the transition probability distribution of an object state on the basis of the training data. By regression analysis, the distribution calculation unit 160 calculates transition probability distribution P(a, φ_{n,t}) showing the probability distribution of state vector φ_{n,t+1} that may be taken at timing t+1 when state vector φ_{n,t} at timing t with respect to object n transits by executing action “a”.

For example, the distribution calculation unit 160 calculates transition probability distribution P by applying a sliding window to the Poisson regression model in which state vector φ_{n,t} is assumed as an input and the occurrence probability per unit time of response at time t+1 is assumed as an output, every action “a”. For example, in a case where one component of state vector φ_{n,t} is “direct mail point for past one week”, the component increases by 1 in a case where a direct mail that is action “a” is executed, and it decreases by 1 when one week that is the period of the sliding window passes.

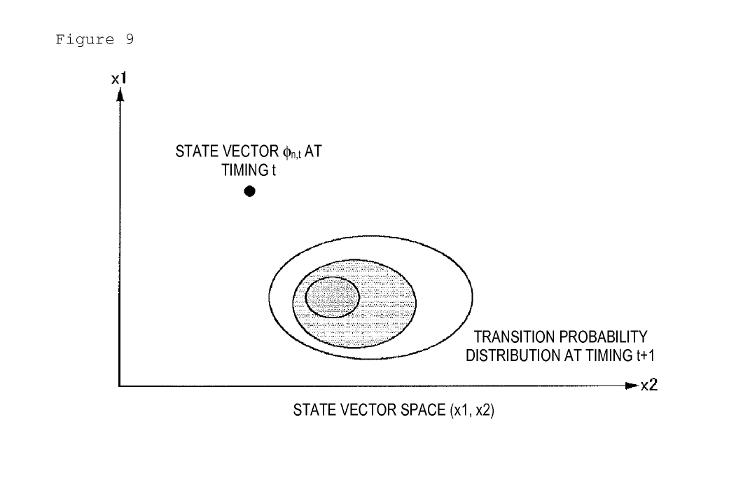

FIG. 9 illustrates one example of the transition probability distribution calculated by the distribution calculation unit 160. The point in the figure shows state vector φ_{n,t} at timing t, and the hatched elliptical region in the figure shows the degree of transition probability according to the density of the hatch. As illustrated in the figure, when action “a” is executed, an object having state vector φ_{n,t} has state vector φ_{n,t+1} of a position corresponding to the probability expressed by transition probability distribution P(a, φ_{n,t}). The distribution calculation unit 160 supplies the calculated transition probability distribution to the simulation unit 170.

Next, in S550, the simulation unit 170 simulates state transition based on the transition probability distribution calculated by the distribution calculation unit 160 and actual reward, according to the action distribution in each state at each timing which is output by the output unit 150 in S190.

For example, every timing in a period, the simulation unit 170 calculates reward acquired in a case where the action distribution output by the output unit 150 is executed, and updates the transition probability distribution according to a result of executing the action distribution. By this means, the simulation unit 170 can acquire the result of executing the optimal action distribution output by the output unit 150.

Thus, the information processing apparatus 10 of the present embodiment enables What-If analysis related to a cost constraint by simulating an actually acquired result by action distribution that satisfies the cost constraint over multiple timings and/or multiple states. By this means, for example, when deciding the budgets of multiple sections in an organization, the information processing apparatus 10 can analyze appropriate budget distribution.

Here, a variation example of the present embodiment is described. The output unit 150 in the information processing apparatus 10 of the present variation example calculates action distribution in a case where, although it is not an essential condition that a cost constraint is satisfied, it is desirable to observe the cost constraint as much as possible. In the present variation example, when executing S170, the processing unit 140 may use constraints according to Equations (6) to (8) instead of using constraints according to Equations (1) to (5).

$$\begin{matrix}{max}_{π ∈ \prod , \{ {σ}_{i} \}} [ {\sum }_{t = 1}^{T} {γ}^{t} {\sum }_{s ∈ S} {\sum }_{a ∈ A} {n}_{t , s , a ,} {\hat{r}}_{t , s , a} - {\sum }_{i = 1}^{T} {η}_{i} {σ}_{i} ] \\ s . t . {Λ}_{s ∈ S} [ {\sum }_{a ∈ A} {n}_{1 , s , a} = {N}_{1 , s} ] & Equation ( 6 ) \\ {Λ}_{t = 1}^{T - 1} {Λ}_{s ∈ S} [ {\sum }_{a ∈ A} {n}_{t + 1 , s , a} = {\sum }_{{s}^{′} ∈ S} {\sum }_{{a}^{′} ∈ A} {\hat{p}}_{s \vert {s}^{′} , {a}^{′}} {n}_{t , {s}^{′} , {a}^{′}} ] & Equation ( 7 ) \\ {Λ}_{i = 1}^{I} ⌈ {\sum }_{( t , s , a ) ∈ {Z}_{i}} {c}_{t , s , a} {n}_{t , s , a} ⋛ ( {C}_{i} ∓ {σ}_{i} ) ⌉ & Equation ( 8 )\end{matrix}$$

Here, σᵢ stands for a slack variable given every cost constraint, and weight coefficient ηᵢ stands for a weight coefficient given to slack variable σᵢ.

In the variation example, instead of giving a constraint of the slack variable by an error between the number of action application objects and the number of estimation objects in Equations (2) and (3), slack variable a, is added to total cost Cᵢ in Equation (8) to assume that the number of action application objects and the number of estimation objects are equal by Equation (7).

In Equation (8), when slack variable σ_{t,s} increases, an error related to the cost constraint increases. Here, in Equation (6), there is a relationship in which the objective function decreases when a term based on the error increases, and the term based on the error increases in proportion to slack variable σ_{t,s.} By this means, the processing unit 140 calculates a condition of keeping the size of the total reward and the matching degree with respect to the cost constraint by introducing the low matching degree with respect to a given cost constraint in the objective function as a penalty value and maximizing the objective function.

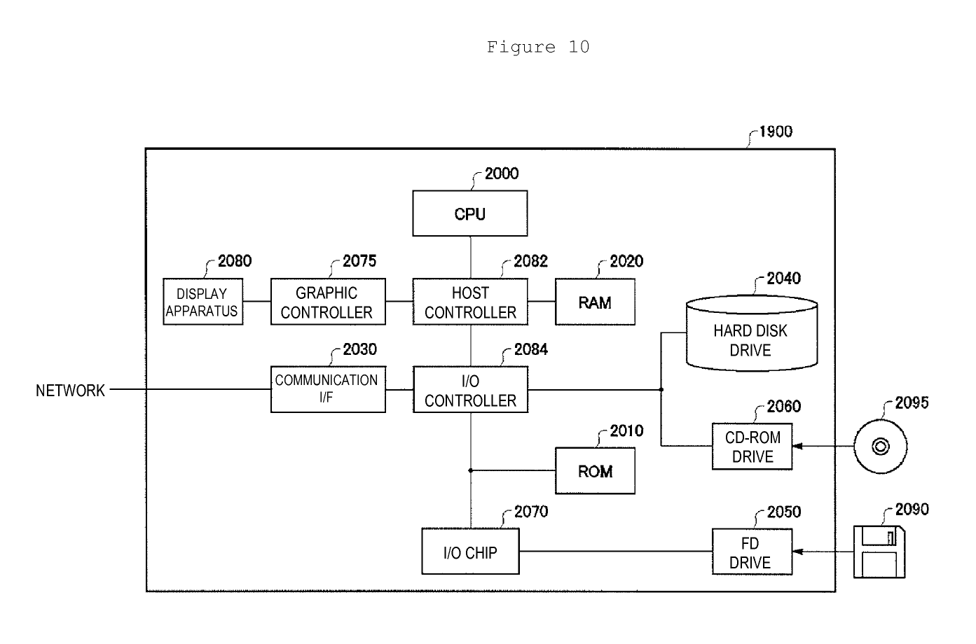

FIG. 10 illustrates one example of a hardware configuration of the computer 1900 that functions as the information processing apparatus 10. The computer 1900 according to the present embodiment includes a CPU periphery having a CPU 2000, a RAM 2020, a graphic controller 2075 and a display apparatus 2080 that are mutually connected by a host controller 2082, an input/output unit having a communication interface 2030, a hard disk drive 2040 and a CD-ROM drive 2060 that are connected with the host controller 2082 by an input/output controller 2084, and a legacy input/output unit having a ROM 2010, a flexible disk drive 2050 and an input/output chip 2070 that are connected with the input/output controller 2084.

The host controller 2082 connects the CPU 2000 and the graphic controller 2075 that access the RAM 2020 at a high transfer rate, and the RAM 2020. The CPU 2000 performs operation on the basis of programs stored in the ROM 2010 and the RAM 2020, and controls each unit. The graphic controller 2075 acquires image data generated on a frame buffer installed in the RAM 2020 by the CPU 2000 or the like, and displays it on the display apparatus 2080. Instead of this, the graphic controller 2075 may include the frame buffer that stores the image data generated by the CPU 2000 or the like, inside.

The input/output controller 2084 connects the communication interface 2030, the hard disk drive 2040 and the CD-ROM drive 2060 that are relatively high-speed input-output apparatuses, and the host controller 2082. The communication interface 2030 performs communication with other apparatuses via a network by wire or wireless. Moreover, the communication interface functions as hardware that performs communication. The hard disk drive 2040 stores a program and data used by the CPU 2000 in the computer 1900. The CD-ROM drive 2060 reads out a program or data from a CD-ROM 2095 and provides it to the hard disk drive 2040 through the RAM 2020.

Moreover, the ROM 2010, the flexible disk drive 2050 and the input/output chip 2070 that are relatively low-speed input/output apparatuses are connected with the input/output controller 2084. The ROM 2010 stores a boot program executed by the computer 1900 at the time of startup and a program depending on hardware of the computer 1900, and so on. The flexible disk drive 2050 reads out a program or data from a flexible disk 2090 and provides it to the hard disk drive 2040 through the RAM 2020. The input/output chip 2070 connects the flexible disk drive 2050 with the input/output controller 2084, and, for example, connects various input/output apparatuses with the input/output controller 2084 through a parallel port, a serial port, a keyboard port and a mouse port, and so on.

A program provided to the hard disk drive 2040 through the RAM 2020 is stored in a recording medium such as the flexible disk 2090, the CD-ROM 2095 and an integrated circuit card, and provided by the user. The program is read out from the recording medium, installed in the hard disk drive 2040 in the computer 1900 through the RAM 2020 and executed in the CPU 2000.

Programs that are installed in the computer 1900 to cause the computer 1900 to function as the information processing apparatus 10 includes a training data acquisition module, a model generation module, a classification module, a calculation module, a cost constraint acquisition module, a processing module, an output module, a distribution calculation module and a simulation module. These programs or modules may request the CPU 2000 or the like to cause the computer 1900 to function as the training data acquisition unit 110, the model generation unit 120, the classification unit 122, the calculation unit 124, the cost constraint acquisition unit 130, the processing unit 140, the output unit 150, the distribution calculation unit 160 and the simulation unit 170.

Information processing described in these programs is read out by the computer 1900 and thereby functions as the training data acquisition unit 110, the model generation unit 120, the classification unit 122, the calculation unit 124, the cost constraint acquisition unit 130, the processing unit 140, the output unit 150, the distribution calculation unit 160 and the simulation unit 170 that are specific means in which software and the above-mentioned various hardware resources cooperate. Further, by realizing computation or processing of information according to the intended use of the computer 1900 in the present embodiment by these specific means, the unique information processing apparatus 10 based on the intended use is constructed.

As an example, in a case where communication is performed between the computer 1900 and an external apparatus or the like, the CPU 2000 executes a communication program loaded on the RAM 2020 and gives an instruction in communication processing to the communication interface 2030 on the basis of processing content described in the communication program. In response to the control of the CPU 2000, the communication interface 2030 reads out transmission data stored in a transmission buffer region installed on a storage apparatus such as the RAM 2020, the hard disk drive 2040, the flexible disk 2090 and the CD-ROM 2095 and transmits it to a network, or writs reception data received form the network in a reception buffer region or the like installed on the storage apparatus. Thus, the communication interface 2030 may transfer transmission/reception data with a storage apparatus by a DMA (direct memory access) scheme, or, instead of this, the CPU 2000 may transfer transmission/reception data by reading out data from a storage apparatus of the transfer source or the communication interface 2030 and writing the data in the communication interface 2030 of the transfer destination or the storage apparatus.

Moreover, the CPU 2000 causes the RAM 2020 to read out all or necessary part of files or database stored in an external storage apparatus such as the hard disk drive 2040, the CD-ROM drive 2060 (CD-ROM 2095) and the flexible disk drive 2050 (flexible disk 2090) by DMA transfer or the like, and performs various kinds of processing on the data on the RAM 2020. Further, the CPU 2000 writes the processed data back to the external storage apparatus by DMA transfer or the like. In such processing, since it can be assumed that the RAM 2020 temporarily holds content of the external storage apparatus, the RAM 2020 and the external storage apparatus or the like are collectively referred to as memory, storage unit or storage apparatus, and so on, in the present embodiment.

Various kinds of information such as various programs, data, tables and databases in the present embodiment are stored on such a storage apparatus and become objects of information processing. Here, the CPU 2000 can hold part of the RAM 2020 in a cache memory and perform reading/writing on the cache memory. In such a mode, since the cache memory has part of the function of the RAM 2020, in the preset embodiment, the cache memory is assumed to be included in the RAM 2020, a memory and/or a storage apparatus except when they are distinguished and shown.

Moreover, the CPU 2000 performs various kinds of processing including various computations, information processing, condition decision and information search/replacement described in the present embodiment, which are specified by an instruction string, on data read from the RAM 2020, and writs it back to the RAM 2020. For example, in a case where the CPU 2000 performs condition decision, it decides whether to satisfy a condition that various variables shown in the present embodiment are larger, smaller, equal to or greater, equal to or less, or equal to other variables or constants, and, in a case where the condition is established (or is not established), it diverges to a different instruction string or invokes a subroutine.

Moreover, the CPU 2000 can search for information stored in a file or database or the like in a storage apparatus. For example, in a case where multiple entries in which the attribute values of the second attribute are respectively associated with the attribute values of the first attribute are stored in a storage apparatus, by searching for an entry in which the attribute value of the first attribute matches a designated condition from multiple entries stored in the storage apparatus and reading out the attribute value of the second attribute stored in the entry, the CPU 2000 can acquire the attribute value of the second attribute associated with the first attribute that satisfies the predetermined condition.

Although the present invention has been described using the embodiment, the technical scope of the present invention is not limited to the range described in the above-mentioned embodiment. It is clear for those skilled in the art to be able to add various changes or improvements to the above-mentioned embodiment. It is clear that a mode in which such changes or improvements are added is included in the technical scope of the present invention, from the description of the claims.

As for the execution order of each processing such as operation, procedures, steps and stages in the apparatuses, systems, programs and methods shown in the claims, specification and figures, terms such as “prior to” and “in advance” are not clearly shown, and it should be noted that they can be realized in an arbitrary order unless the output of prior processing is used in subsequent processing. Regarding the operation flows in the claims, the specification and the figures, even if an explanation is given using terms such as “first” and “next”, it does not mean that it is essential to implement them in this order.

### REFERENCE SIGNS LIST

10 . . . Information processing apparatus

110 . . . training data acquisition unit

120 . . . Model generation unit

122 . . . Classification unit

124 . . . Calculation unit

130 . . . Cost constraint acquisition unit

140 . . . Processing unit

150 . . . Output units

160 . . . Distribution calculation unit

170 . . . Simulation unit

1900 . . . Computer

2000 . . . CPU

2010 . . . ROM

2020 . . . RAM

2030 . . . Communication interface

2040 . . . Hard disk drives

2050 . . . Flexible disk drive

2060 . . . CD-ROM drive

2070 . . . Input/output chip

2075 . . . Graphic controller

2080 . . . Display apparatus

2082 . . . Host controller

2084 . . . Input/output controller

2090 . . . Flexible disk

2095 . . . CD-ROM

1. A computer implemented method of optimizing an action in a transition model in which a number of objects in each state transits according to the action, the method comprising:
acquiring, with a processing device, multiple cost constraints including a cost constraint that constrains a total cost of the action over at least one of multiple timings and multiple states;
assuming action distribution in each state at each timing as a decision variable in an optimization problem and maximize an objective function subtracting a term based on an error between an actual number of objects with the action in each state at each timing and an estimated number of objects in each state at each timing based on state transition by the transition model, from a total reward in a whole period, while satisfying the multiple cost constraints; and
outputting the action distribution in each state at each timing that maximizes the objective function.

2. The method of claim 1, further comprising assuming the action distribution and a range of the error in each state at each timing as the variable of the optimization problem, and maximizes the objective function.

3. The method of claim 1, further comprising maximizing the objective function subtracting a term weighting the error from the total reward in the whole period.

4. The method of claim 1, further comprising, with respect to an actual number of objects with an action in each state at one timing, calculating a population of objects that transit to each state at the one timing by state transition based on action distribution in each state at a timing previous to the one timing, and assuming the population of objects as an estimated number of objects.

5. The method of claim 1, further comprising maximizing the objective function by further using a constraint condition that a total of the actual number of objects with the action in each state at each timing is equal to a predefined total number of objects.

6. The method of claim 1, further comprising acquiring a cost constraint that constrains a total cost of every action.

7. The method of claim 1, further comprising:
acquiring training data that records response to an action with respect to multiple objects; and
generating the transition model based on the training data.

8. The method of claim 7, further comprising classifying the multiple objects included in the training data into each state, and calculating a state transition probability based on to which state an object of each state transits according to the action.

9. The method of claim 8, further comprising generating a state vector of an object based on an action and response to each of the multiple objects included in the training data, and classifying the multiple objects into multiple states by classifying the multiple objects by an axis in which prediction accuracy when performing regression of a future reward by the state vector is maximum or by an axis in which variance of the state vector is maximum.

10. The method of claim 7, further comprising:
calculating transition probability distribution of an object state based on the training data; and
simulating state transition based on the transition probability distribution, according to the action distribution in each state at each timing that is output by the output unit.
